(19) United States
(12) Patent Application Publication
(10) Pub. No.: US 2026/0166795 A1
(43) Pub. Date: Jun. 18, 2026

(54) INJECTION MOLDING MACHINE AND FLUIDITY MEASUREMENT METHOD

(71) Applicant: Sodick Co., Ltd., Kanagawa (JP)

(72) Inventor: Shuji AIBA, Kanagawa (JP)

(73) Assignee: Sodick Co., Ltd., Kanagawa (JP)

(21) Appl. No.: 19/347,748

(22) Filed: Oct. 2, 2025

(30) Foreign Application Priority Data
Dec. 16, 2024 (JP) 2024-220046

(51) Int. Cl. B29C 45/77; B29C 45/30; B29C 45/47

(52) U.S. Cl. CPC B29C 45/77; B29C 45/30; B29C 45/47; B29C 2945/76006; B29C 2945/7618; B29C 2945/76381

(57) ABSTRACT

An injection molding machine includes an injection unit, a measurement unit, a position sensor, a pressure sensor, and a controller. The measurement unit includes a measurement cylinder, a die having a die hole, a purge opening provided in the measurement cylinder, and a flow path switching pin that switches a discharge destination of a molding material to either one of the die and the purge opening. The controller is configured to advance a plunger so that the pressure of the molding material matches a set test load, discharge the molding material from the die hole, and calculate a melt flow rate.

### CROSS-REFERENCE TO RELATED APPLICATION

This application claims the priority benefit of Japanese application serial No. 2024-220046, filed on Dec. 16, 2024. The entirety of the above-mentioned patent application is hereby incorporated by reference herein and made a part of this specification.

### TECHNICAL FIELD

The disclosure relates to an injection molding machine and a fluidity measurement method using the injection molding machine.

### BACKGROUND ART

There is a demand to understand the characteristics of molding materials used in injection molding. For example, understanding the characteristics of molding materials makes it possible to use the characteristics as a reference for deriving molding conditions or for quality control. Parameters that indicate the characteristics of molding materials include, for example, viscosity and fluidity.

US2024/0123666A and US2025/0018627A disclose a viscosity measurement unit that can be attached in place of a nozzle in an injection molding machine. With this apparatus, the mechanism of the injection molding machine can be diverted for viscosity measurement, and viscosity measurement equivalent to a capillary rheometer can be performed under an environment closer to actual injection molding.

Depending on the types of molding materials, fluidity may be more suitable than viscosity as a parameter representing characteristics. For example, in comparative analysis of molding materials with high pressure dependency, it is more appropriate to compare based on fluidity.

Melt flow rate is known as one of the indicators showing fluidity. More specifically, melt flow rate is expressed as melt mass flow rate (MFR) [g/10 min] or melt volume flow rate (MVR) [cm³/10 min]. Usually, in measuring melt flow rate, a dedicated measurement apparatus called an extrusion plastometer is used, but extrusion plastometers are relatively expensive and cannot be said to be widely prevalent among users of injection molding machines. Besides, work such as manually filling the cylinder with a molding material is required, making measurement laborious.

The standard measurement method for melt flow rate is specified in JIS K 7210-1:2014 (corresponding to ISO 1133-1:2011) and JIS K 7210-2:2014 (corresponding to ISO 1133-2:2011).

The disclosure provides an injection molding machine and a fluidity measurement method that are capable of measuring melt flow rate more simply by utilizing the mechanism of the injection molding machine.

### SUMMARY

According to the disclosure, an injection molding machine is provided, including: an injection unit including an injection axis that extrudes and injects a molding material; a measurement unit attached to the injection unit; a position sensor measuring a position of the injection axis; a pressure sensor measuring a pressure of the molding material; and a controller. The measurement unit includes: a measurement cylinder which is attached to the injection unit and through which the molding material injected by the injection unit flows; a die attached to the measurement cylinder and having a die hole configured to allow the molding material to flow through; a purge opening provided in the measurement cylinder, having a larger cross-sectional area than the die hole, and configured to allow the molding material to flow through; and a flow path switching pin selectively switching a discharge destination of the molding material to one of the die and the purge opening. The controller is configured to, in response to measurement start being instructed, meter the molding material, advance the injection axis so that the pressure of the molding material matches a set test load, and discharge the molding material from the die hole. Then, the controller is configured to calculate a melt flow rate using any one of a mass of a test piece obtained by cutting the molding material discharged from the die hole every predetermined time, a distance by which the injection axis moves in a predetermined time, and a time required for the injection axis to move a predetermined distance.

According to the injection molding machine of the disclosure, measurement of melt flow rate can be performed by utilizing the mechanism of the injection molding machine. In particular, since preliminary preparation and measurement can be performed simply, the burden on the operator who measures melt flow rate can be reduced.

### BRIEF DESCRIPTION OF THE DRAWINGS

FIG. 1 is a schematic configuration view of the injection molding machine according to an embodiment of the disclosure in a state where the injection nozzle is attached.

FIG. 2 is a schematic configuration view of the injection molding machine according to an embodiment of the disclosure in a state where the measurement unit is attached.

FIG. 3 is a perspective view of the measurement unit as viewed from above.

FIG. 4 is a perspective view of the measurement unit as viewed from below.

FIG. 5 is a side cross-sectional view of the measurement unit.

FIG. 6 is a VI-VI arrow view of the measurement unit.

FIG. 7 is a cross-sectional view of the die.

FIG. 8 is a block diagram of the controller.

FIG. 9 is an example of the GUI during measurement of melt mass flow rate.

FIG. 10 is an example of the GUI during measurement of melt volume flow rate.

FIG. 11 is an example of a flowchart during measurement of melt mass flow rate.

FIG. 12 is an example of a flowchart during measurement of melt volume flow rate.

### DESCRIPTION OF THE EMBODIMENTS

Hereinafter, embodiments of the disclosure will be described using the drawings. In each drawing, some components may be omitted from illustration for purposes such as improving visibility. The various modification examples described below may be implemented in any combination with each other.

An injection molding machine of the present embodiment includes an injection unit 1 that extrudes and injects a molding material with an injection axis, a clamping unit (not shown) that opens and closes and clamps a mold (not shown), and a controller 7 that controls the injection unit 1 and the clamping unit. In the case of performing injection molding, the injection unit 1 plasticizes the molding material, meters a predetermined amount, and then injects the molding material from an injection nozzle 46. The clamping unit holds the mold and is configured to be capable of opening and closing and clamping the mold. In injection molding, the clamping unit closes the mold and applies a clamping force of a predetermined pressure to the mold in the case of the molding material being injected. After the molding material injected from the injection nozzle 46 into the cavity of the mold is cooled and becomes a molded product, the clamping unit opens the mold to discharge the molded product, and closes the mold again. Known configurations such as direct pressure type or toggle type can be adopted as the clamping unit.

In this specification, materials that can be injected by the injection molding machine are broadly referred to as a molding material, and include materials with resin as the main material, as well as MIM (metal injection molding) materials in which resin as a binder is added to metal powder, and CIM (ceramic injection molding) materials in which resin as a binder is added to ceramic powder. In addition, an injection molding machine using thermoplastic molding materials will be described as an example, but the disclosure is also applicable to an injection molding machine using thermosetting molding materials. Thermosetting molding materials include LIM (liquid injection molding) materials, which are thermosetting liquid materials.

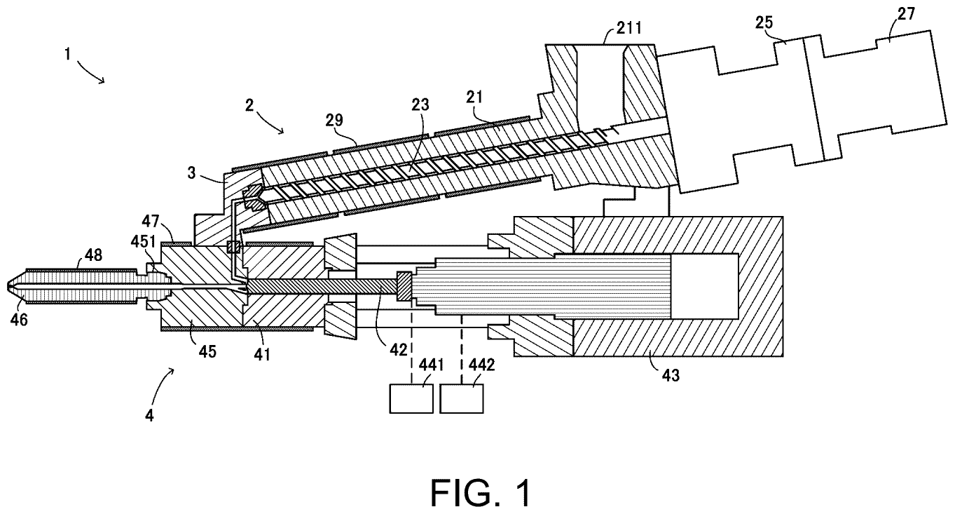

The injection molding machine of the present embodiment is a so-called screw-preplasticating injection molding machine in which a plasticizing device 2 and an injection device 4 are configured separately. As shown in FIG. 1, the injection unit 1 includes the plasticizing device 2, a junction 3, and the injection device 4. In FIG. 1, some configurations are shown as cross-sectional views. In the following, the left side in FIG. 1, that is, the side where the molding material is injected, is referred to as the front side. And, the right side in FIG. 1, that is, the side where the molding material is supplied, is referred to as the rear side.

The plasticizing device 2 includes a plasticizing cylinder 21, a plasticizing screw 23, a backflow prevention device 25, a plasticizing screw drive device 27, and a heater 29. The plasticizing cylinder 21 is a hollow cylinder that is heated to a predetermined temperature by the heater 29 such as a band heater. At the rear end portion of the plasticizing cylinder 21, a material inlet 211 to which the molding material is supplied is formed. The plasticizing screw 23 is rotatably provided within the plasticizing cylinder 21. The plasticizing screw 23 sends the molding material supplied into the plasticizing cylinder 21 from the material inlet 211 forward while melting the molding material with heat from the heater 29 and shear heat. The backflow prevention device 25 is any actuator that advances the plasticizing screw 23, and is, for example, a fluid pressure cylinder or an electric cylinder. The backflow prevention device 25 may be any actuator that advances the plasticizing screw 23 in response to completion of metering to block the flow path and prevent backflow of the molding material during injection. Alternatively, the backflow prevention device 25 may be a valve provided on any position of the injection unit 1 and capable of blocking the flow path of the molding material. The plasticizing screw drive device 27 is any actuator that rotates the plasticizing screw 23, and is, for example, a hydraulic motor or an electric motor.

The junction 3 connects the plasticizing cylinder 21 of the plasticizing device 2 and the injection cylinder 41 of the injection device 4. The junction 3 may be heated to a predetermined temperature by the heater.

The injection device 4 includes an injection cylinder 41, a plunger 42 which is an injection axis, a plunger drive device 43, a position sensor 441, a pressure sensor 442, a nozzle cylinder 45, an injection nozzle 46, and heaters 47 and 48.

The injection cylinder 41 is a hollow cylinder that is heated to a predetermined temperature by the heater 47 such as a band heater. The molding material sent from the plasticizing cylinder 21 is stored in the injection cylinder 41. The plunger 42 is a substantially columnar member that is provided to be able to advance and retreat within the injection cylinder 41. In the screw-preplasticating injection molding machine, the plunger 42 corresponds to an injection axis for extruding and injecting the molding material. The plunger drive device 43 is any actuator that advances and retreats the plunger 42, and is, for example, a hydraulic cylinder or an electric cylinder. The plunger 42 and the piston rod of the plunger drive device 43 are connected via a coupling.

The position sensor 441 is a sensor that reads the position of the plunger 42. The position sensor 441 may be any sensor that can measure the position of the plunger 42 directly or indirectly, and is, for example, a linear scale. In the case of the plunger drive device 43 being an electric cylinder, the position sensor 441 may be a rotary encoder.

The pressure sensor 442 is a sensor that reads the pressure applied to the plunger 42. The pressure sensor 442 may be any sensor that can measure the pressure applied to the plunger 42 directly or indirectly, and is, for example, a load cell provided between the plunger 42 and the piston rod. In the case of the plunger drive device 43 being a hydraulic cylinder, the pressure sensor 442 may be a hydraulic gauge. In the case of the plunger drive device 43 being an electric cylinder, the position sensor 441 may be a motor current measuring device or a torque measuring device.

The nozzle cylinder 45 is a cylinder that is attached in front of the injection cylinder 41 and is heated to a predetermined temperature by the heater 47 such as a band heater. The nozzle cylinder 45 has a supply flow path that connects the junction 3 and the injection cylinder 41, and a discharge flow path that connects the injection cylinder 41 and the injection nozzle 46, respectively. A nozzle attachment hole 451 to which the injection nozzle 46 can be attached is formed on the front surface of the nozzle cylinder 45. More specifically, a female thread that is screwed onto a male thread formed on the rear end portion of the injection nozzle 46 is formed on the inner wall of the nozzle attachment hole 451. The injection nozzle 46 is attached to the nozzle cylinder 45 during injection molding. The injection nozzle 46 is heated to a predetermined temperature by the heater 48 such as a coil heater.

The molding material melted by the plasticizing device 2 is sent to the injection cylinder 41 through the junction 3 and the nozzle cylinder 45. In the injection cylinder 41, the molding material is stored in front of the plunger 42, and a desired amount of the molding material is metered. After metering, backflow to the plasticizing device 2 is prevented by the backflow prevention device 25, and then, in response to the plunger 42 being advanced, the molding material is sent to the injection nozzle 46 via the nozzle cylinder 45. In this way, the molding material is injected from the injection nozzle 46.

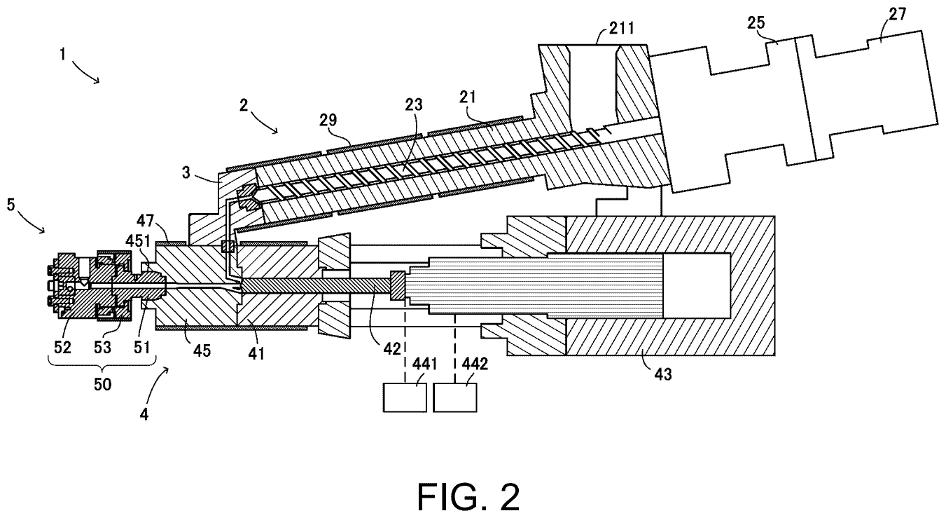

Here, the measurement unit 5 of the present embodiment will be described. The measurement unit 5 is attached to the injection unit 1 in the case of measuring the melt flow rate of the molding material. The attachment position of the measurement unit 5 may be in front of the injection cylinder 41, but from the viewpoint of workability, preferably the measurement unit 5 is attached in place of the injection nozzle 46, as shown in FIG. 2. That is to say, the injection nozzle 46 may be removed from the nozzle cylinder 45, and the measurement cylinder 50 of the measurement unit 5 may be attached to the nozzle attachment hole 451 of the nozzle cylinder 45. The method for attaching the measurement unit 5 will be described in detail later.

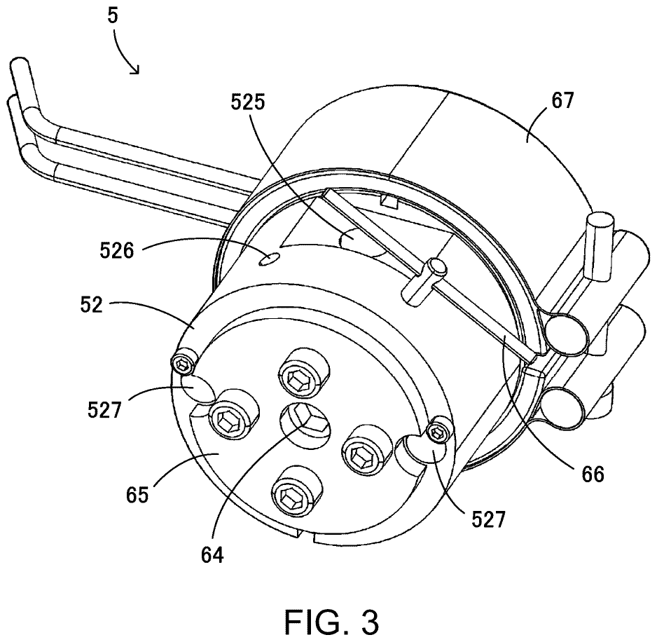

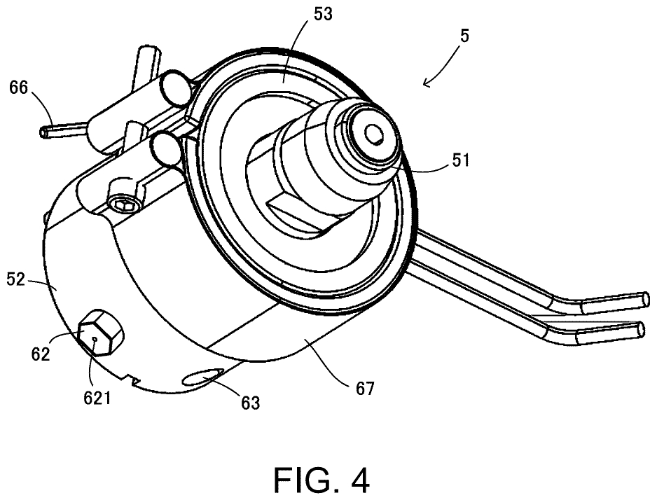

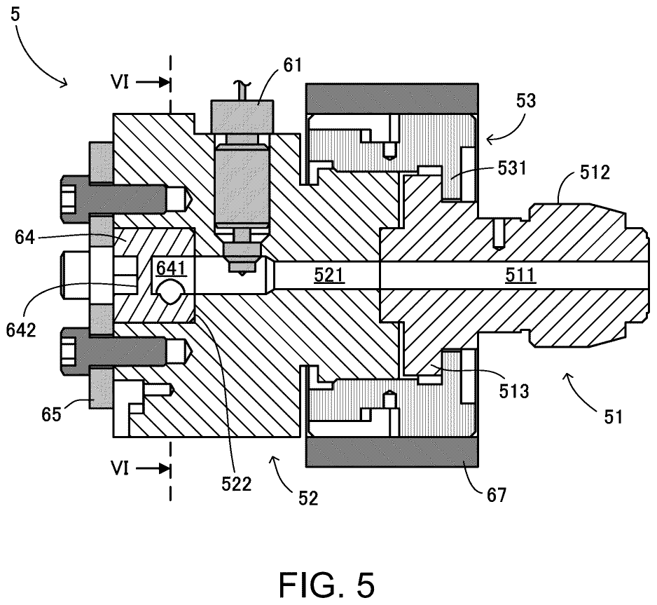

As shown in FIG. 3 to FIG. 6, the measurement unit 5 of the present embodiment includes a measurement cylinder 50 to which a pressure sensor 61 is attached, a die 62, a purge opening 63, a flow path switching pin 64, a fixing plate 65, a positioning rod 66, and heaters 67 and 68.

The measurement cylinder 50 is attached to the injection device 4 of the injection unit 1, and the molding material injected by the injection device 4 flows therethrough. The measurement cylinder 50 of the present embodiment includes a first cylinder 51 and a second cylinder 52, and the first cylinder 51 and the second cylinder 52 are configured to be separable. The first cylinder 51 and the second cylinder 52 are fastened by a cover nut 53 serving as a fastener. The heater 67, which is a band heater, is wound around the cover nut 53.

The first cylinder 51 has a flow path 511, an attachment section 512, and a flange 513. The flow path 511 is formed to penetrate through the inside of the first cylinder 51 in the axial direction and is connected to the discharge flow path of the nozzle cylinder 45. The attachment section 512 is provided at the rear end portion of the first cylinder 51 and is formed with a male thread that is screwed into the female thread formed in the nozzle attachment hole 451. The flange 513 is provided at the front end portion of the first cylinder 51 and comes into contact with the cover nut 53.

The second cylinder 52 has a flow path 521, a flow path switching pin attachment hole 522, a flow path 523, a die attachment hole 524, a pressure sensor attachment hole 525, a positioning rod insertion hole 526, and a heater attachment hole 527. Additionally, a male thread that is screwed into the female thread formed in the inner hole of the cover nut 53 is formed at the rear end portion of the second cylinder 52.

The flow path 521 is formed axially inside the second cylinder 52 and is connected to the flow path 511 and the flow path switching pin attachment hole 522. The flow path switching pin attachment hole 522 is a hole formed in the front surface of the second cylinder 52. The flow path switching pin 64 is rotatably fitted into the flow path switching pin attachment hole 522. The flow path 523 is formed radially inside the second cylinder 52 and is connected to the flow path switching pin attachment hole 522 and the die attachment hole 524. In the present embodiment, two flow paths 523 are formed.

The die attachment hole 524 is a hole formed in the side surface of the second cylinder 52. In the present embodiment, two die attachment holes 524 are provided, with the die 62 fixed to one, and the other functioning as the purge opening 63. That is, in the present embodiment, the die attachment hole 524 and the purge opening 63 are mutually interchangeable, but it is not essential that the die 62 can be attached to the purge opening 63. In other words, it is sufficient that at least one of the holes communicating with the flow path 523 can attach the die 62. In the present embodiment, a female thread is formed on the inner wall of the die attachment hole 524 and a male thread is formed on the outer periphery of the die 62, and the die attachment hole 524 and the die 62 are screwed to each other to facilitate attachment and detachment.

The pressure sensor attachment hole 525 is a hole formed to penetrate through the side surface of the second cylinder 52 and the flow path 521. The pressure sensor 61 is attached to the pressure sensor attachment hole 525. The positioning rod insertion hole 526 is a hole formed to penetrate through the side surface of the second cylinder 52 and the flow path switching pin attachment hole 522. The positioning rod 66 is inserted through the positioning rod insertion hole 526. The heater attachment hole 527 is a hole formed in the second cylinder 52, and the heater 68, which is a cartridge heater, is inserted therethrough.

The pressure sensor 61 is a pressure transducer that is inserted through the pressure sensor attachment hole 525 of the measurement cylinder 50 and measures the pressure of the molding material inside the measurement cylinder 50. More specifically, in the present embodiment, the pressure sensor 61 measures the pressure of the molding material flowing through the flow path 521 of the second cylinder 52.

As will be described later, in the case of discharging the molding material from the die 62 during measurement of melt flow rate, the plunger 42 is advanced with the set test load. At this time, that is, during measurement, feedback control is performed based on the measured pressure of the molding material so that the pressure of the molding material matches the test load. The test load, that is, the pressure of the molding material during measurement of melt flow rate, is very low compared to the pressure of the molding material that occurs during normal injection molding. Therefore, the pressure sensor 442 of the injection device 4, which is intended for use in pressure detection during injection molding, may not be able to perform pressure detection with high accuracy during measurement of melt flow rate. Thus, by providing the pressure sensor 61 suitable for low-pressure measurement in the measurement cylinder 50 and using the detection value from the pressure sensor 61 during measurement of melt flow rate as a reference, more highly accurate feedback control can be performed for the plunger 42, which consequently improves the accuracy of melt flow rate measurement. The measurable range of the pressure sensor 61 is preferably a low-pressure range of, for example, greater than 0 MPa and approximately 20 MPa or less. However, in the case where acceptable measurement accuracy is obtained even with use of the pressure sensor 442, the pressure sensor 61 may be omitted, and the pressure sensor 442 may be used for feedback control during measurement of melt flow rate.

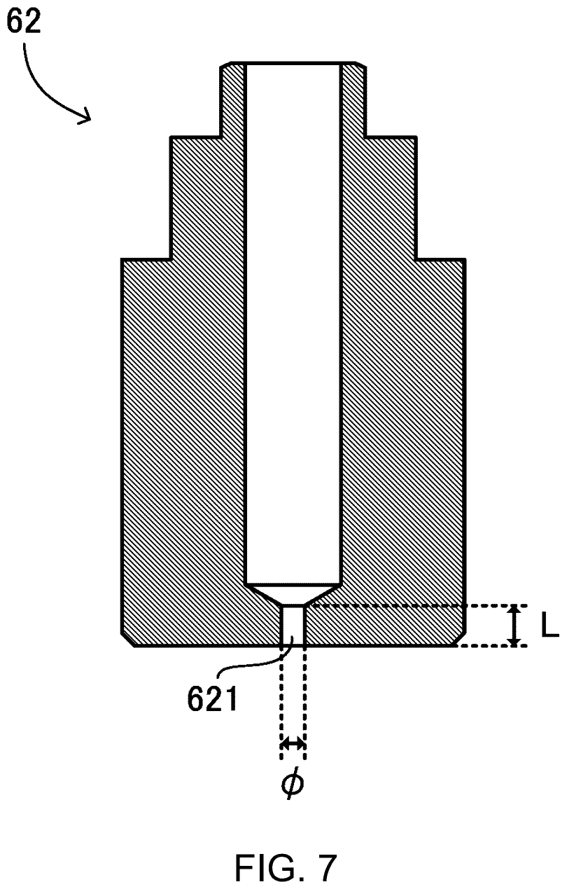

As shown in FIG. 7, the die 62 having a die hole 621 configured to allow the molding material to flow through is attached to the measurement cylinder 50. In the case of performing measurement equivalent to the measurement method specified in JIS K 7210-1:2014 (corresponding to ISO 1133-1:2011) and JIS K 7210-2:2014 (corresponding to ISO 1133-2:2011), a standard die or a half-size die described in the standard is used as the die 62. The standard die is a die 62 having a die hole 621 with an effective length L of 8.000 mm and a hole diameter P of 2.095 mm. The half-size die is a die 62 having a die hole 621 with an effective length L of 4.000 mm and a hole diameter p of 1.050 mm. The die hole 621 is positioned at the terminal end portion of the die 62, and the molding material sent via the flow path switching pin 64 flows therethrough. The flow path in the die 62 other than the die hole 621 may have a sufficient cross-sectional area that does not hinder the flow of the molding material.

The purge opening 63 is a hole provided in the measurement cylinder 50 and is configured to allow the molding material to flow through. The purge opening 63 has a sufficient cross-sectional area that does not hinder the flow of the molding material, and at least the cross-sectional area of the purge opening 63 is larger than the cross-sectional area of the die hole 621. The diameter of the purge opening 63 is, for example, approximately 4.0 mm or more and approximately 6.0 mm or less. In measuring the melt flow rate, as preliminary preparation, work of purging is performed to replace the existing molding material present inside the injection unit 1 with the molding material to be measured and to discharge the molding material until the state becomes stable. Since the die hole 621 of the die 62 has a very small hole diameter, attempting to discharge the molding material from the die hole 621 during purging takes a very long time and also imposes large load on the apparatus. Therefore, purging can be performed efficiently by discharging the molding material from the purge opening 63 during purging.

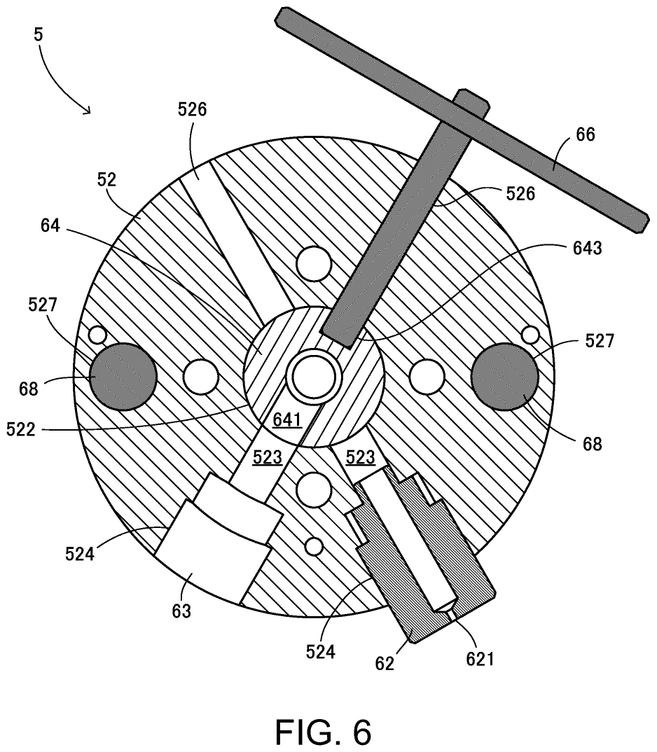

In the present embodiment, as shown in FIG. 6, the die attachment hole 524 with nothing attached thereto is used directly as the purge opening 63. However, a cylinder having a through hole of sufficient size may be attached to the die attachment hole 524, and the through hole may be used as the purge opening 63. The cylinder may be configured to be screwed into the die attachment hole 524. By using the cylinder, it is possible to prevent the molding material discharged during purging from adhering to the inner wall of the die attachment hole 524.

The flow path switching pin 64 selectively switches the discharge destination of the molding material supplied from the flow paths 511 and 521 to either one of the die 62 and the purge opening 63. The flow path switching pin 64 of the present embodiment is a cylindrical member rotatably fitted into the flow path switching pin attachment hole 522, and has a flow path 641, a tool hole 642, and a recess 643. The flow path 641 is bent 90° at the intermediate portion, with the inlet side connected to the flow path 521 and the outlet side connected to one of the flow paths 523. By rotating the flow path switching pin 64, the flow path 523 connected to the flow path 641 can be switched. The tool hole 642 is formed on the front surface of the flow path switching pin 64 and is a hole that fits with a tool of any shape. In the present embodiment, a hexagonal hole that fits with a hexagonal wrench is formed as the tool hole 642. By fitting a tool into the tool hole 642, the flow path switching pin 64 can be rotated. The recess 643 is a hole formed on the side surface of the flow path switching pin 64, and is provided at a position to be connected to one of the positioning rod insertion holes 526 in the case of the flow path 641 being connected to one of the flow paths 523. That is, in the present embodiment, the flow path switching pin 64 is provided on the central axis of the second cylinder 52, and in the case of the outlet side of the flow path 641 being connected to the flow path 523, the recess 643 and the positioning rod insertion hole 526 are positioned on opposite sides across the central axis.

The fixing plate 65 is a plate-shaped member fixed to the front surface of the second cylinder 52 with bolts or the like, and comes into contact with the flow path switching pin 64 to prevent the flow path switching pin 64 from falling out. An opening is formed in the central portion of the fixing plate 65 so as not to cover the tool hole 642.

The positioning rod 66 has a rod-shaped member that is inserted through the positioning rod insertion hole 526. The positioning rod 66 is inserted through the positioning rod insertion hole 526 after rotating the flow path switching pin 64 to select the flow path to be used. Thereby, the tip of the positioning rod 66 fits into the recess 643, and the flow path switching pin 64 is accurately positioned while preventing unintentional rotation.

The flow path switching pin 64 of the present embodiment is configured to be manually rotatable using a tool, but may be configured to be automatically rotatable by any actuator such as a fluid pressure cylinder or an electric motor. At this time, the switching of the die caused by the flow path switching pin 64 may be controlled by the controller 7.

In order to prevent the molding material discharged from the die 62 and the purge opening 63 from scattering, it is preferable to attach the measurement cylinder 50 to the injection unit 1 so that the die 62 and the purge opening 63 face downward. Specifically, the measurement cylinder 50 is attached by the following procedure. First, the cover nut 53 is inserted through the first cylinder 51, and the attachment section 512 of the first cylinder 51 is screwed into the nozzle attachment hole of the nozzle cylinder 45. Next, the first cylinder 51 and the second cylinder 52 are engaged, and positioned so that the die attachment hole 524 of the second cylinder 52 faces downward. In this state, the cover nut 53 is screwed to the second cylinder 52, and the cover nut 53 is rotated until a wall surface 531 of the cover nut 53 comes into contact with the flange 513 of the first cylinder 51. In this way, the first cylinder 51 and the second cylinder 52 are fastened.

Each member attached to the second cylinder 52 may be attached before fastening the first cylinder 51 and the second cylinder 52, or may be attached after fastening. Additionally, although the first cylinder 51 and the second cylinder 52 are fastened by the cover nut 53 in the present embodiment, other fasteners such as bolts may be used.

After completing the fastening of the first cylinder 51 and the second cylinder 52 by the above procedure, positioning is performed so that the die 62 and the purge opening 63 face downward in the case of the first cylinder 51 being screwed into the nozzle attachment hole 451. Therefore, in the case of the first cylinder 51 and the second cylinder 52 fastened by the above procedure, the first cylinder 51 and the second cylinder 52 may be attached to the nozzle cylinder 45 in the assembled state thereafter. However, in the case of the injection molding machine to be attached being changed, positioning based on the same procedure is required again.

In order to make the die 62 and the purge opening 63 face downward, it is desirable that the angle formed by the straight line passing through the center of the die 62 and the straight line passing through the center of the purge opening 63 be 40° or less in front view.

Here, the controller 7 of the present embodiment will be described. The controller 7 is configured to control the injection unit 1 and the clamping unit, and to be capable of calculating the melt flow rate using any one of the mass of a test piece obtained by cutting the molding material discharged from the die hole 621 every predetermined time, the distance by which the plunger 42 moves in a predetermined time, and the time required for the plunger 42 to move a predetermined distance. Based on the mass of a test piece obtained by cutting the molding material discharged from the die hole 621 every predetermined time, the melt mass flow rate can be calculated directly. Based on the distance by which the plunger 42 moves in a predetermined time or the time required for the plunger 42 to move a predetermined distance, the melt volume flow rate can be calculated directly. Further, based on the density of the molding material, mutual conversion between the melt mass flow rate and the melt volume flow rate is possible.

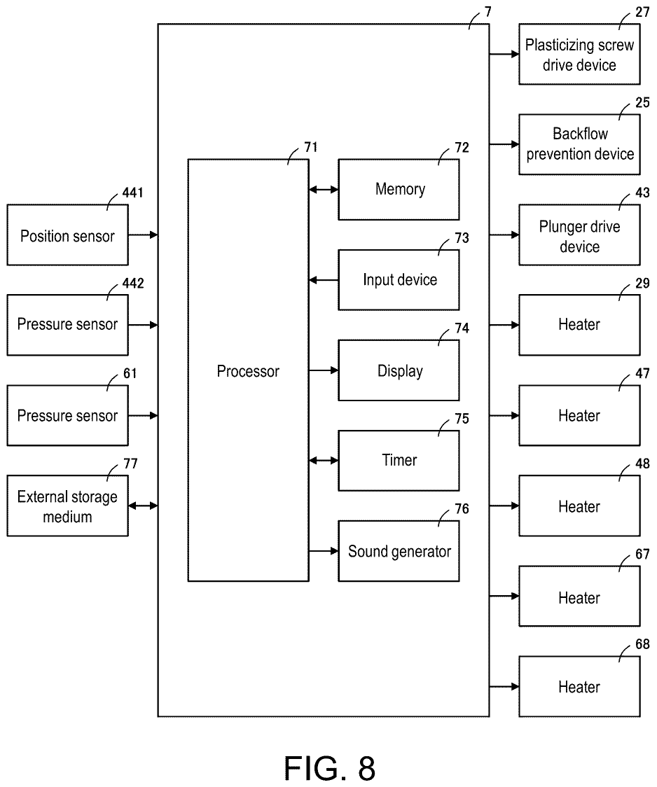

The controller 7 may be configured by optionally combining hardware and software, and as shown in FIG. 8, for example, includes a processor 71, a memory 72, an input device 73, a display 74, a timer 75, and a sound generator 76. The processor 71 is any arithmetic circuit such as a CPU and performs various calculations for controlling each component, as well as calculations related to melt flow rate calculation. The memory 72 may be configured by optionally combining RAM, ROM, and auxiliary memories, and stores data required for calculations of the processor 71. Also, the memory 72 may store standard test conditions for major molding materials. The input device 73 may have an electronic circuit that converts the content input by an operator into electrical signals. The input device 73 and the display 74 may each be individual devices, or may be configured to include a device such as a touch panel that serves as both. In the present embodiment, an operation panel including a touch panel and input keys is provided as a device that serves as both the input device 73 and the display 74. The timer 75 can measure time used for various controls. The sound generator 76 may be any acoustic transducer that converts electrical signals into sounds, and is, for example, a speaker or a buzzer.

In the case of measuring the melt mass flow rate, a notificator may be provided to notify the operator of the timing for cutting the molding material discharged from the die hole 621. In the present embodiment, the notificator is configured by the display 74 and the sound generator 76. That is, the display 74 displays messages or images to inform the operator of the timing for cutting the molding material. Further, the sound generator 76 outputs buzzer sounds or voices to inform the operator of the timing for cutting the molding material. The notificator is not limited to these devices, and may be configured to include other devices such as lamps, or one or more devices may be used in any combination.

The controller 7 controls the plasticizing screw drive device 27, the backflow prevention device 25, and the plunger drive device 43 of the injection unit 1 during injection molding and during melt flow rate measurement to perform melting, metering, and injection of the molding material.

The controller 7 controls the heaters 29, 47, 48, 67, and 68 to heat the plasticizing cylinder 21, the injection cylinder 41, the nozzle cylinder 45, the injection nozzle 46, and the measurement cylinder 50 to desired temperatures. However, during injection molding, the heaters 67 and 68 are not used. In addition, during melt flow rate measurement, the heater 48 is not used. Temperature sensors such as thermocouples may be provided in each component, and the heaters 29, 47, 48, 67, and 68 may be feedback controlled based on the measured temperatures.

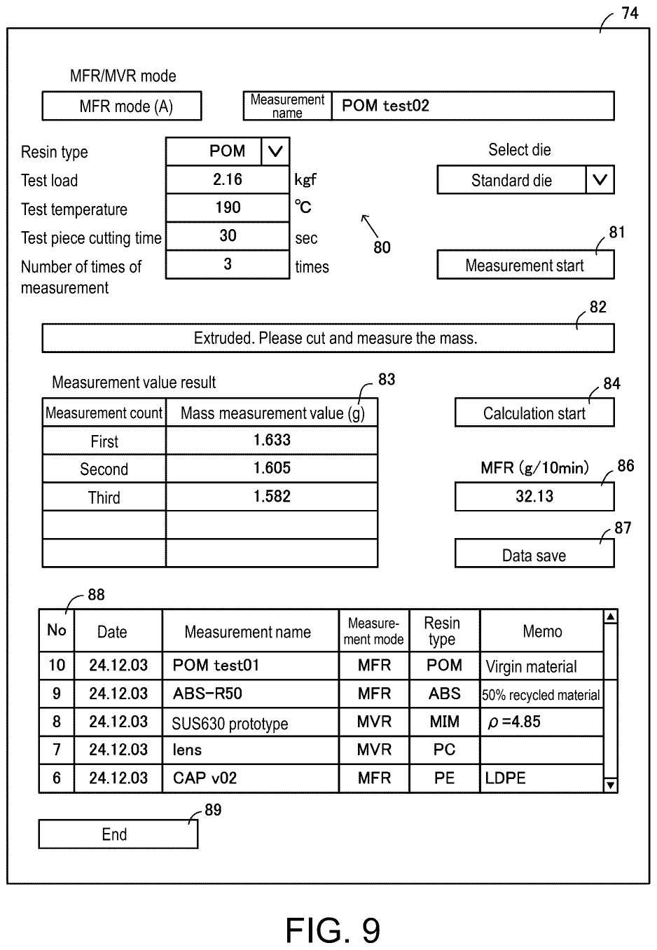

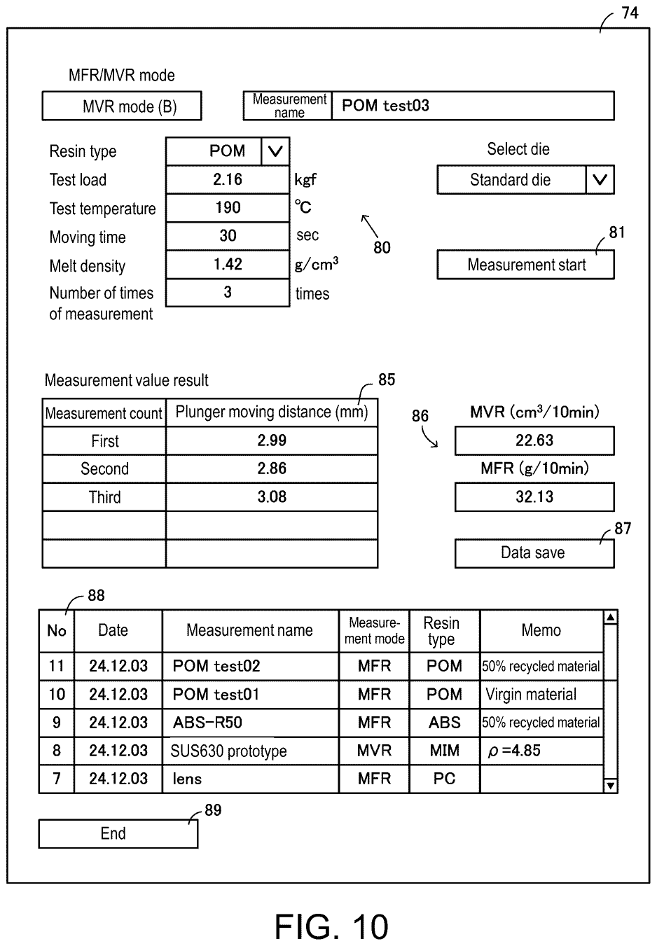

FIG. 9 and FIG. 10 show an example of a GUI displayed on the display 74 during melt flow rate measurement. The GUI during melt flow rate measurement can be accessed from the GUI during normal injection molding. The injection molding machine of the present embodiment is configured to be capable of switching between an MFR mode that directly measures the melt mass flow rate and an MVR mode that directly measures the melt volume flow rate.

The GUI related to the MFR mode includes, as shown in FIG. 9, for example, a test condition input area 80, a measurement start button 81, a message display area 82, a measurement result input area 83, a calculation start button 84, a calculation result display area 86, a data save button 87, a data display area 88, and an end button 89. The GUI related to the MVR mode includes, as shown in FIG. 10, for example, a test condition input area 80, a measurement start button 81, a calculation start button 84, a measurement result display area 85, a calculation result display area 86, a data save button 87, a data display area 88, and an end button 89.

The test condition input area 80 includes a switching button between MFR mode and MVR mode, an input field for measurement name, a selection button for the die 62 to be used, and an input field for test conditions. The die 62 may be selectable from a standard die or a half-size die. For major molding materials, standard test conditions are known. Therefore, by selecting the type of molding material (i.e. resin type), standard test conditions may be automatically input into the input field for test conditions. The automatically input test conditions may be changed as required. In addition, the operator can manually input test conditions.

The test conditions for the MFR mode include:
Test load [kgf]: setting pressure for advancing the plunger 42
Test temperature [° C.]: setting temperature of the injection unit 1 and the measurement cylinder 50
Test piece cutting time [sec]: time interval for cutting the molding material discharged from the die hole 621
Number of times of measurement [times]: number of times for cutting the molding material to obtain test pieces.

In the case of measuring the distance by which the plunger 42 moves in a predetermined time, the test conditions for the MVR mode include:
Test load [kgf]: setting pressure for advancing the plunger 42
Test temperature [° C.]: setting temperature of the injection unit 1 and the measurement cylinder 50
Moving time [sec]: time for advancing the plunger 42
Number of times of measurement [times]: number of times for measuring the moving distance of the plunger 42.

In the case of measuring the time required for the plunger 42 to move a predetermined distance, the test conditions for the MVR mode include:
Test load [kgf]: setting pressure for advancing the plunger 42
Test temperature [° C.]: setting temperature of the injection unit 1 and the measurement cylinder 50
Moving distance [mm]: distance to advance the plunger 42
Number of times of measurement [times]: number of times for measuring the moving time of the plunger 42.

In the present embodiment, the melt volume flow rate measured in the MVR mode is configured to be convertible to melt mass flow rate for display. Therefore, in the present embodiment, the test condition input area 80 of the MVR mode further includes an input field for:
Density [g/cm³]: density of the molding material at the test temperature.

The melt mass flow rate measured in the MFR mode may be configured to be convertible to melt volume flow rate for display, and in that case, the input field for density may also be provided in the MFR mode.

In response to the measurement start button 81 being pressed, the controller 7 receives an instruction of measurement start and meters the molding material, advances the plunger 42 so that the pressure of the molding material matches the set test load, and discharges the molding material from the die hole 621 of the die 62.

In the present embodiment, in measuring the melt mass flow rate in the MFR mode, the operator manually cuts the test piece. The timing for cutting the molding material is transmitted to the operator via the notificator. The message display area 82 constitutes the notificator in the display 74. However, a cutter that cuts the molding material discharged from the die hole 621 may be provided and configured so that the test piece is cut automatically. In this case, the notificator may be omitted.

In the MFR mode of the present embodiment, the operator measures the mass of the test piece with a mass meter and manually inputs the measurement result into the measurement result input area 83. Thereafter, in response to the calculation start button 84 being pressed, the calculated melt mass flow rate value is displayed in the calculation result display area 86. However, a mass meter connected to the controller 7 may be provided and configured so that the mass of the test piece is input automatically.

In the MVR mode of the present embodiment, the distance by which the plunger 42 moves in a predetermined time is displayed in the measurement result display area 85, and the melt volume flow rate value calculated based on the distance is displayed in the calculation result display area 86. Additionally, the time required for the plunger 42 to move a predetermined distance may be displayed in the measurement result display area 85, and the melt volume flow rate value calculated based on the time may be displayed in the calculation result display area 86. In the present embodiment, the melt mass flow rate value calculated based on the melt volume flow rate and density is also displayed in the measurement result display area 85.

In response to the data save button 87 being pressed, the measurement data is saved and displayed as a list in the data display area 88. The measurement data may include information on the measurement date, the measurement mode used, the measurement name, the type of die 62 used, the type of molding material, the test conditions, and the measurement results. The measurement data may be saved in the memory 72 of the controller 7, or may be saved in an external storage medium 77 such as a portable storage medium like a flash memory. The measurement data once saved in the memory 72 of the controller 7 may be output to the external storage medium 77. Past measurement data saved in the memory 72 or the external storage medium 77 may be read and displayed in the data display area 88. Each item of the measurement data displayed in the data display area 88 may be optionally switchable between display and non-display. The configuration may be made to allow supplementary information to be added to the measurement data.

In response to the end button 89 being pressed, the GUI for melt flow rate measurement is closed and moves to the GUI for normal injection molding.

Here, an example of a fluidity measurement method using the injection molding machine of the present embodiment will be described.

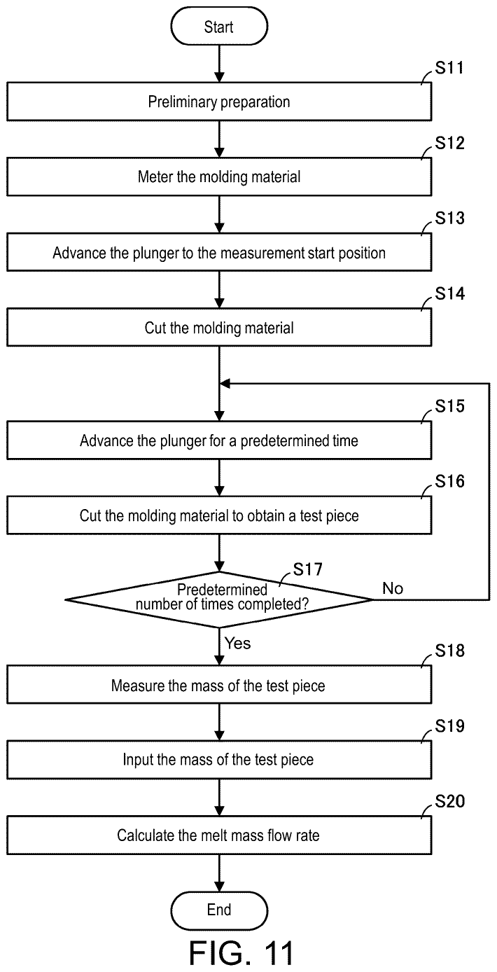

FIG. 11 is an example of a flowchart in the case of calculating the melt mass flow rate using the MFR mode.

First, preliminary preparation is performed for measurement (S11). The preliminary preparation may include the following steps. The operator sets the test conditions required for measurement as described above. The injection unit 1 including the plasticizing device 2 and the injection device 4, and the measurement cylinder 50 are respectively heated to a predetermined temperature, that is, test temperature. After the temperature rise of each component is completed, the molding material to be measured is fed into the material inlet 211, and purging of the molding material is performed. During purging, the discharge destination of the molding material by the flow path switching pin 64 is set to the purge opening 63, and the molding material sent from the plasticizing device 2 and the injection device 4 passes through the measurement cylinder 50 and is discharged from the purge opening 63. Purging includes drawling purging performed with the plunger 42 fixed, and metering purging that performs metering in the injection cylinder 41 and injection by the plunger 42, and either one of these may be implemented or these may be implemented in combination. After purging is completed, the flow path switching pin 64 is rotated to switch the discharge destination of the molding material to the die 62.

Since the molding material can change in state in the case of remaining in the injection molding machine for a long time, it is desirable to start measurement immediately after purging for high-precision measurement. According to the injection molding machine of the present embodiment, after purging, the discharge destination of the molding material can be switched from the purge opening 63 to the die 62 by the flow path switching pin 64, and since large-scale work is not required, measurement can be started quickly.

In response to the measurement start button 81 being pressed and measurement start being instructed, metering of the molding material is performed (S12). The plasticizing screw 23 rotates and sends the molding material to the injection cylinder 41 while melting the molding material. The molding material sent to the injection cylinder 41 is stored in front of the plunger 42 while pushing down the plunger 42. In the stage where the plunger 42 reaches a predetermined position, metering is considered complete, the plasticizing screw 23 stops, and backflow prevention is performed by the backflow prevention device 25. The metered value may be any amount sufficient for performing measurement, and for example, the maximum amount that can be metered by the injection device 4 may be metered. In an extrusion plastometer, after filling the cylinder with the molding material, a step of compressing with a rod to remove gas is required, but in the case of metering with an injection molding machine as in the present embodiment, metering can be performed to hardly entrap air, so this work is basically unnecessary.

Next, movement of the plunger 42 is started, and the plunger 42 advances to the measurement start position (S13). The plunger 42 is feedback controlled based on the pressure measured by the pressure sensor 61 so that the pressure of the molding material matches the set test load. As the plunger 42 advances, molten molding material is discharged from the die hole 621 of the die 62. The plunger 42 advances while applying a predetermined test load to the molding material. The test is started in the stage where the plunger 42 reaches the predetermined measurement start position.

The notificator informs the operator that the plunger 42 has reached the measurement start position, and the operator receives this and cuts the molding material being discharged from the die hole 621 (S14). Since the molding material cut at this time is not used for measurement, the molding material may be discarded.

The plunger 42 continues to advance, and whenever the time set as the test piece cutting time elapses, the notificator informs the operator that the timing for cutting the molding material has come. The operator receives this and cuts the molding material being discharged from the die hole 621 to obtain a test piece. That is, advancing the plunger 42 for a predetermined time and cutting the molding material to obtain a test piece are repeated for the set number of times of measurement (S15 to S17).

In cutting the molding material, movement of the plunger 42 may be temporarily stopped. That is, the controller 7 may temporarily stop the plunger 42 during test start and during test piece collection. The plunger 42 may resume advancing after a predetermined time elapses, or may resume advancing based on an instruction from the operator.

The operator measures the mass of the test piece and inputs the measured mass into the measurement result input area 83 of the controller 7 (S18 to S19). In response to the calculation start button 84 being pressed, the controller 7 calculates the melt mass flow rate based on the following formula and displays the calculation result in the calculation result display area 86 (S20). Here,
MFR [g/10 min]: melt mass flow rate
mₙ [g]: mass of the test piece from the n^{th} measurement
t [sec]: test piece cutting time
n [times]: number of times of measurement.

$$MFR = \frac{600 \times {{\sum }^{n}}_{k = 1} {m}_{n}}{t \times n} \qquad [ Formula 1 ]$$

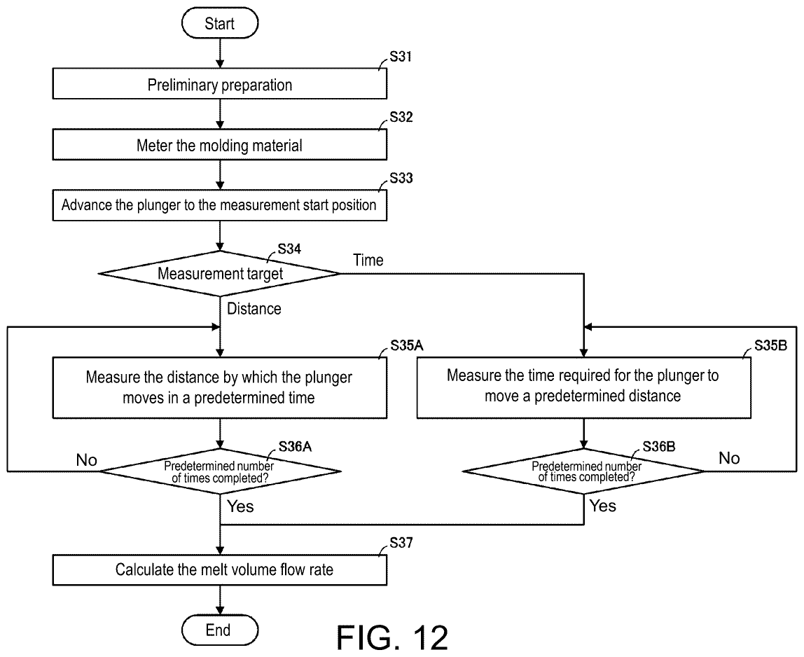

FIG. 12 is an example of a flowchart in the case of calculating the melt volume flow rate using the MVR mode.

In the same procedure as calculating the melt mass flow rate, preliminary preparation (S31), metering of the molding material (S32), and advancement of the plunger 42 to the measurement start position (S33) are performed. The subsequent flow branches according to whether the measurement target is the distance by which the plunger 42 moves in a predetermined time or the time required for the plunger 42 to move a predetermined distance (S34).

The flow for the case of measuring the distance by which the plunger 42 moves is as follows. Whenever the time set as the moving time elapses, the position of the plunger 42 at that point is read and the moving distance is calculated. That is, measuring the distance by which the plunger 42 moves in a predetermined time is repeated for the set number of times of measurement (S35A to S36A). The controller 7 calculates the melt volume flow rate based on the following formula and displays the calculation result in the calculation result display area 86 (S37). Here,
MVR [cm³/10 min]: melt volume flow rate
A [cm²]: cross-sectional area of the plunger 42
lₙ [cm]: moving distance of the plunger 42 from the n^{th} measurement
t [sec]: moving time of the plunger 42
n [times]: number of times of measurement.

$$MVR = \frac{600 \times {{\sum }^{n}}_{k = 1} {l}_{n}}{t \times n} \qquad [ Formula 2 ]$$

The flow for the case of measuring the time for the plunger 42 to move is as follows. Whenever the plunger 42 moves the distance set as the moving distance, the time required for the movement is calculated. That is, measuring the time required for the plunger 42 to move the predetermined distance is repeated for the set number of times of measurement (S35B to S36B). The controller 7 calculates the melt volume flow rate based on the following formula and displays the calculation result in the calculation result display area 86 (S37). Here,
MVR [cm³/10 min]: melt volume flow rate
A [cm²]: cross-sectional area of the plunger 42
l [cm]: moving distance of the plunger 42
tₙ [sec]: moving time of the plunger 42 from the n^{th} measurement
n [times]: number of times of measurement.

$$MVR = \frac{A \times 600 \times l \times n}{{{\sum }^{n}}_{k = 1} {t}_{n}} \qquad [ Formula 3 ]$$

The melt volume flow rate may be converted to a melt mass flow rate and displayed in the calculation result display area 86. The controller 7 can calculate the melt mass flow rate from the melt volume flow rate based on the following formula. Here,
MFR [g/10 min]: melt mass flow rate
MVR [cm³/10 min]: melt volume flow rate
ρ [g/cm³]: density of the molding material at test temperature

Furthermore, conversely, the melt mass flow rate may be converted to a melt volume flow rate and displayed in the calculation result display area 86.

$$MFR = MVR \times ρ \qquad [ Formula 4 ]$$

In the case where density is known, such information may be referenced, but density may be calculated based on the mass of a test piece obtained by cutting the molding material discharged from the die hole 621 in the case of the plunger 42 moving a predetermined distance. Specifically, the density can be calculated based on the following formula. Here,
ρ [g/cm³]: density of the molding material at test temperature
mₙ [g]: mass of the test piece from the n^{th} measurement
A [cm²]: cross-sectional area of the plunger 42
l [cm]: moving distance of the plunger 42
n [times]: number of times of measurement.

$$ρ = \frac{{{\sum }^{n}}_{k = 1} {m}_{n}}{A \times l \times n} \qquad [ Formula 5 ]$$

The density may be calculated on the injection molding machine using the same device as used in the case of measuring the melt flow rate. At this time, the injection molding machine may be configured to be capable of displaying a GUI related to a density measurement mode for measuring density on the display 74. The operator inputs the following as the test conditions for the density measurement mode:
Test load [kgf]: setting pressure for advancing the plunger 42
Test temperature [° C.]: setting temperature of the injection unit 1 and the measurement cylinder 50
Moving distance [mm]: distance to advance the plunger 42
Number of times of measurement [times]: number of times for cutting the molding material to obtain test pieces.

In the case of measuring density, theoretically, measurement at test temperature and test pressure equivalent to those during subsequent melt flow rate measurement is required. However, since the test pressure is sufficiently low, the test pressure does not need to be substantially identical. After metering the molding material and moving the plunger 42 to the measurement start position, the molding material is cut to obtain a test piece whenever the plunger 42 moves the distance set as the moving distance, based on the same procedure as the measurement in the MFR mode. Based on the measured mass of the test piece, the controller 7 calculates the density from the above-mentioned formula for display.

According to the injection molding machine of the present embodiment, it is possible to measure the melt flow rate using the mechanism of the injection molding machine. Therefore, it becomes possible to measure the melt flow rate at a lower cost than preparing an extrusion plastometer. In addition, compared to an extrusion plastometer, the injection molding machine of the present embodiment has advantages in causing less work burden on the operator and particularly reducing the effort for preliminary preparation. Furthermore, viscosity measurement equivalent to an extrusion plastometer can be performed under an environment closer to actual injection molding.

The injection molding machine that implements the fluidity measurement method of the present embodiment may be a so-called in-line screw injection molding machine in which the plasticizing device 2 and the injection device 4 are integrally configured. The in-line screw injection molding machine includes, as a device that serves as both the plasticizing device 2 and the injection device 4, a cylinder and a screw provided to be rotatable and able to advance and retreat within the cylinder. In the in-line screw injection molding machine, the screw corresponds to the injection axis, and a check ring is provided at the front of the screw as backflow prevention device. However, a screw-preplasticating injection molding machine including the backflow prevention device 25 that advances the plasticizing screw 23 to prevent backflow, like the injection molding machine of the present embodiment, is superior in stability and reproducibility of metering and injection compared to the in-line screw injection molding machine, so the melt flow rate of the molding material can be measured more accurately.

The disclosure is not limited to the configurations of the embodiments shown in the drawings, as several examples have been specifically shown, and various modifications or applications are possible within the scope that does not depart from the technical concept of the disclosure.

1. An injection molding machine, comprising:
an injection unit comprising an injection axis that extrudes and injects a molding material;
a measurement unit attached to the injection unit;
a position sensor measuring a position of the injection axis;
a pressure sensor measuring a pressure of the molding material; and
a controller,
wherein the measurement unit comprises:
a measurement cylinder which is attached to the injection unit and through which the molding material injected by the injection unit flows;
a die attached to the measurement cylinder and having a die hole configured to allow the molding material to flow through;
a purge opening provided in the measurement cylinder, having a larger cross-sectional area than the die hole, and configured to allow the molding material to flow through; and
a flow path switching pin selectively switching a discharge destination of the molding material to one of the die and the purge opening,
wherein the controller is configured to, in response to measurement start being instructed, meter the molding material, advance the injection axis so that the pressure of the molding material matches a set test load, discharge the molding material from the die hole, and calculate a melt flow rate using any one of a mass of a test piece obtained by cutting the molding material discharged from the die hole every predetermined time, a distance by which the injection axis moves in a predetermined time, and a time required for the injection axis to move a predetermined distance.

2. The injection molding machine according to claim 1, wherein the controller comprises a notificator notifying an operator of a timing for cutting the molding material discharged from the die hole, and
the controller is configured to calculate a melt mass flow rate using the mass of the test piece obtained by cutting the molding material discharged from the die hole every predetermined time.

3. The injection molding machine according to claim 2, wherein the notificator is a display.

4. The injection molding machine according to claim 2, wherein the notificator is a sound generator.

5. The injection molding machine according to claim 1, further comprising a cutter cutting the molding material discharged from the die hole,
wherein the controller is configured to calculate a melt mass flow rate using the mass of the test piece obtained by cutting the molding material discharged from the die hole every predetermined time.

6. The injection molding machine according to claim 1, wherein the controller is configured to calculate a melt volume flow rate using the distance by which the injection axis moves in the predetermined time or the time required for the injection axis to move the predetermined distance, and calculate a melt mass flow rate using the melt volume flow rate and a density of the molding material.

7. The injection molding machine according to claim 1, wherein the pressure sensor is a pressure transducer inserted through the measurement cylinder.

8. The injection molding machine according to claim 1, wherein the injection unit comprises:
a plasticizing device having a plasticizing cylinder to which the molding material is supplied, and a plasticizing screw which is provided to be rotatable within the plasticizing cylinder;
an injection device having an injection cylinder in which the molding material sent from the plasticizing cylinder is stored, and a plunger which is the injection axis provided to be able to advance and retreat within the injection cylinder; and
a junction connecting the plasticizing cylinder and the injection cylinder.

9. A fluidity measurement method, using the injection molding machine according to claim 1, the fluidity measurement method comprising:
preliminary preparation;
metering the molding material;
advancing the injection axis to a measurement start position and cutting the molding material discharged from the die hole;
advancing the injection axis for a predetermined time and cutting the molding material discharged from the die hole to obtain a test piece;
measuring a mass of the test piece;
inputting the mass of the test piece to the controller; and
calculating a melt mass flow rate by the controller.

10. The fluidity measurement method according to claim 9, wherein the preliminary preparation comprises:
setting test conditions;
heating the injection unit and the measurement cylinder to a predetermined temperature;
purging the molding material in a state where the purge opening is selected as the discharge destination of the molding material; and
switching the discharge destination of the molding material to the die after purging.

11. A fluidity measurement method, using the injection molding machine according to claim 1, the fluidity measurement method comprising:
preliminary preparation;
metering the molding material;
advancing the injection axis to a measurement start position;
measuring the distance by which the injection axis moves in the predetermined time or the time required for the injection axis to move the predetermined distance; and
calculating a melt volume flow rate by the controller.

12. The fluidity measurement method according to claim 11, wherein the preliminary preparation comprises:
setting test conditions;
heating the injection unit and the measurement cylinder to a predetermined temperature;
purging the molding material in a state where the purge opening is selected as the discharge destination of the molding material; and
switching the discharge destination of the molding material to the die after purging.
